(19) United States
(12) Patent Application Publication
(10) Pub. No.: US 2007/0088958 A1
(43) Pub. Date: Apr. 19, 2007

(54) Method and system for workflow management of electronic documents

(75) Inventor: Hood Qa'Im-maqami, Weehawken, NJ (US)

Correspondence Address: MORGAN, LEWIS & BOCKIUS LLP, 1701 MARKET STREET, PHILADELPHIA, PA, 19103-2921, US

(73) Assignee: Lehman Brothers Inc., New York, NY (US)

(21) Appl. No.: 11/498,270

(22) Filed: Aug. 2, 2006

Related U.S. Application Data
(60) Provisional application No. 60/705,844, filed on Aug. 5, 2005.

(51) Int. Cl. H04L 9/00

(52) U.S. Cl. 713/176

(57) ABSTRACT

A document management system is disclosed. A server maintains an electronic document and software for managing a workflow relating to the electronic document. The workflow includes a plurality of steps. One or more parties can access the electronic document via a network, use the software, and alter the electronic document. The steps of the workflow differ depending on the identity of the party accessing the document.

### CROSS REFERENCE TO RELATED APPLICATIONS

This application claims priority to U.S. Provisional Patent Application No. 60/705,844, filed Aug. 5, 2005, which is hereby incorporated by reference in its entirety.

### FIELD OF THE INVENTION

The present invention relates to workflow management systems for electronic documents.

### BACKGROUND OF THE INVENTION

The current state of the derivative confirmation space (as well as certain other types of contract negotiation involving multiple parties, e.g., a party and a counterparty) can be characterized as manual and paper-based. Documents are generated electronically, but once they leave the company, they are faxed. In addition, such documents (marked up and/or signed) are returned as faxes, which are then scanned back into the records management systems. Metadata associated with the fax must also be re-keyed.

### SUMMARY OF THE INVENTION

The present invention is directed to a document management system. A server maintains an electronic document and software for managing a workflow relating to the electronic document. The workflow includes a plurality of steps. One or more parties can access the electronic document via a network, use the software, and alter the electronic document. The steps of the workflow differ depending on the identity of the party accessing the document.

The present invention is also directed to a method for managing a workflow relating to an electronic document. The workflow includes a plurality of steps. The electronic document is stored on a server. Access to the electronic document is provided to one or more parties. An alteration to the electronic document and/or an indication of approval in connection with the workflow is received from one or more of the parties. The steps of the workflow differ depending on the identity of the party accessing the document.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1A is an exemplary computer architecture for implementing the present invention;

FIG. 1B is an exemplary flow diagram illustrating the various steps of the present invention;

FIG. 2 is an exemplary user interface that may be used in connection with the present invention;

FIG. 3 is an exemplary user interface that may be used in connection with the present invention;

FIG. 4 is an exemplary user interface that may be used in connection with the present invention;

FIG. 5 is an exemplary user interface that may be used in connection with the present invention;

FIG. 6 is an exemplary user interface that may be used in connection with the present invention; and

FIG. 7 is an exemplary flow diagram illustrating a preferred embodiment of a method of the present invention.

### DETAILED DESCRIPTION OF THE PREFERRED EMBODIMENTS

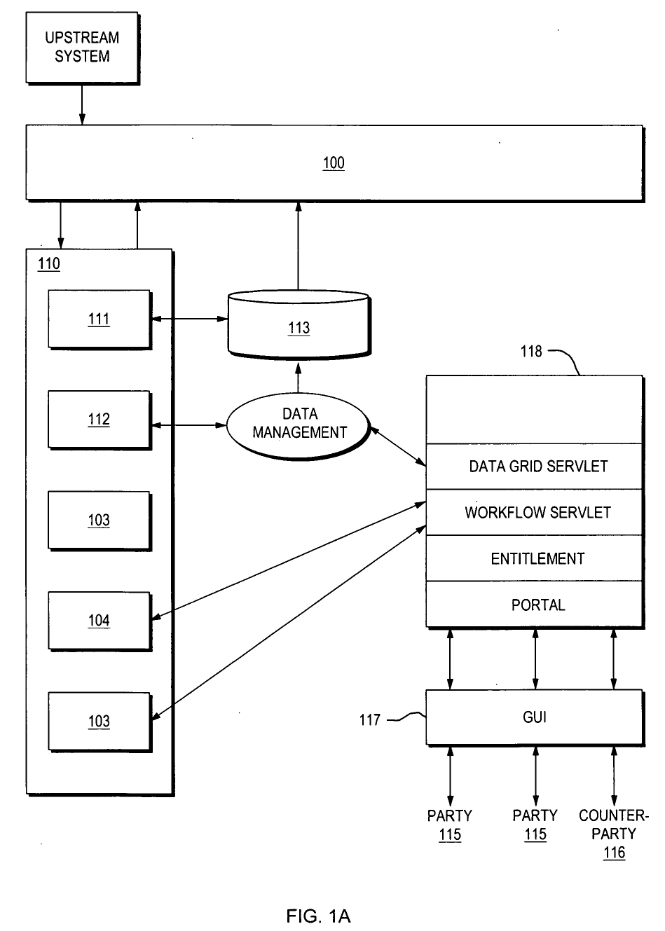

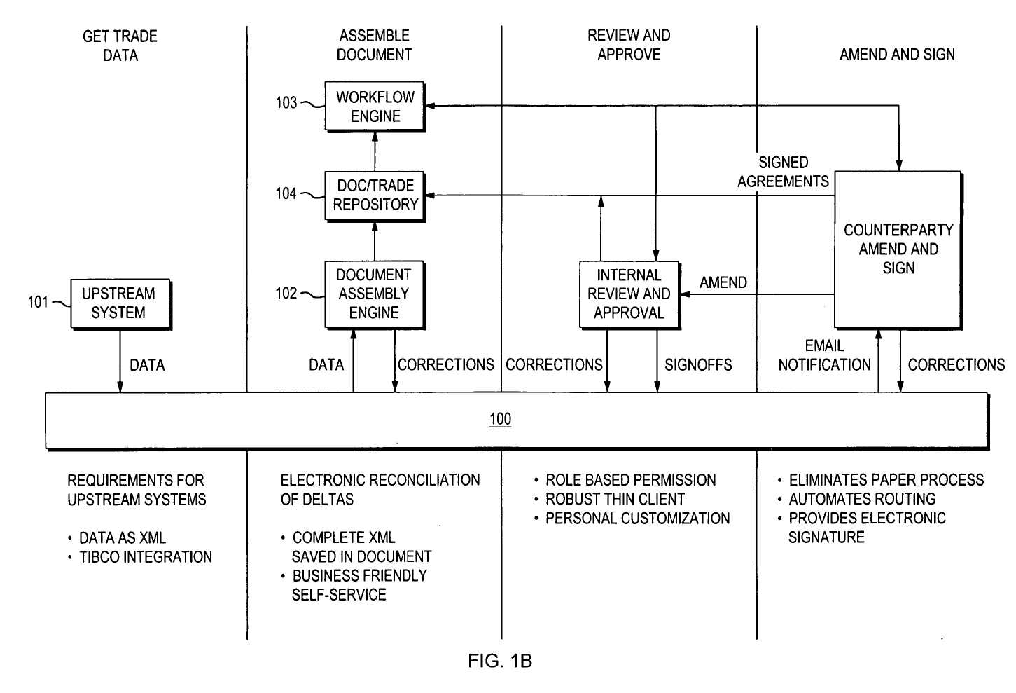

A preferred embodiment of the present invention eliminates the manual/paper process by exposing to a company's counterparties (via a secure portal) the same document management functionality that the company's internal confirmers use. With reference to FIG. 1A, an exemplary computer architecture is shown. Data (e.g., trade data) is obtained from upstream system 101. Server farm 110 includes a transaction manager 111 that interacts with database 113, a data mapping module 112, a document assembly engine 103, a document repository 104, and a workflow engine 103. One or more parties (e.g., party(ies) 115 and counterparty(ies) 116) access the document management functionality via a secure portal 118 using interface 117. Thus, the server farm 110 is maintained behind a firewall of the party (or the counterparty, depending on which party is hosting the document management system). Alternatively, the server farm 110 is maintained by a third party. In a preferred embodiment, the third party is trusted by both the party 115 and the counterparty 116.

An exemplary, basic workflow that has been automated via a portal, or secure extranet, is set forth below and described in more detail with reference to FIG. 1B. Generally, the exemplary work flow comprises the following steps: review; approve; send to counterparty; and amend or sign. The workflow may comprise other steps in alternate embodiments, within the scope of the present invention. If the counterparty signs, the process is complete. If the counterparty amends, the process begins again at review. Thus, “review” for the company is the same as “amend” for the counterparty; “approve” or the company is the same as “sign” for the counterparty. Thus, the steps of the workflow differ depending on the identity of the party accessing the document.

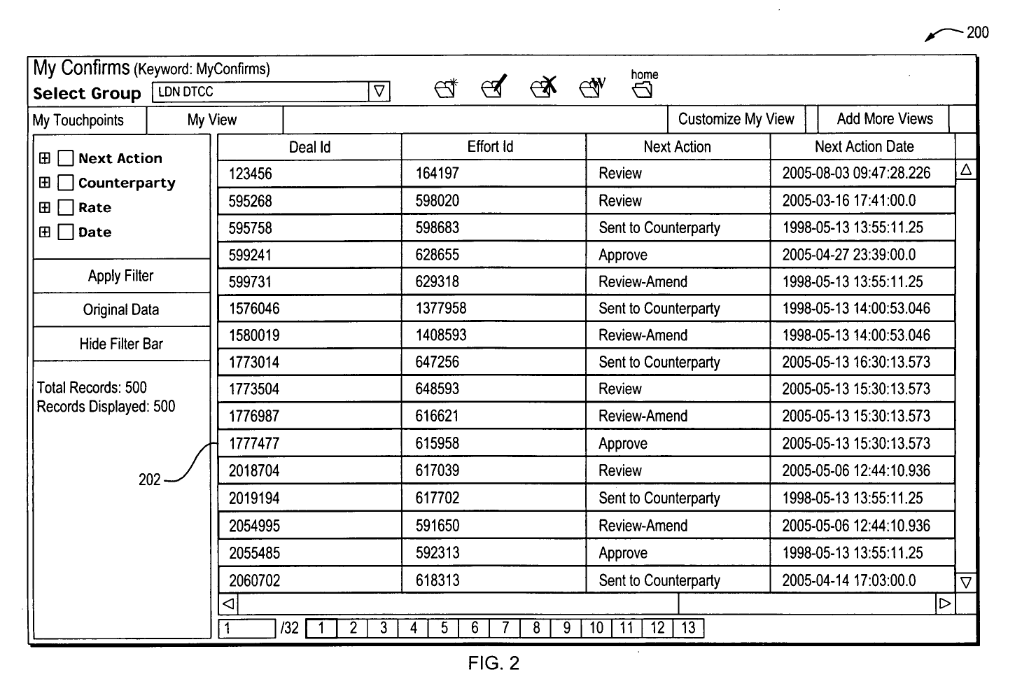

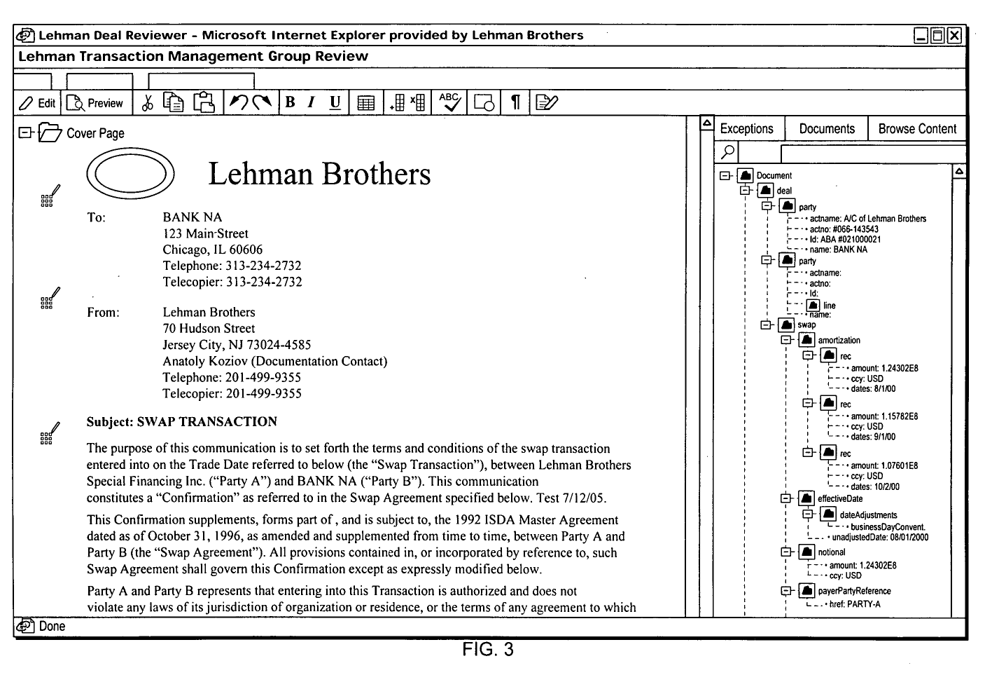

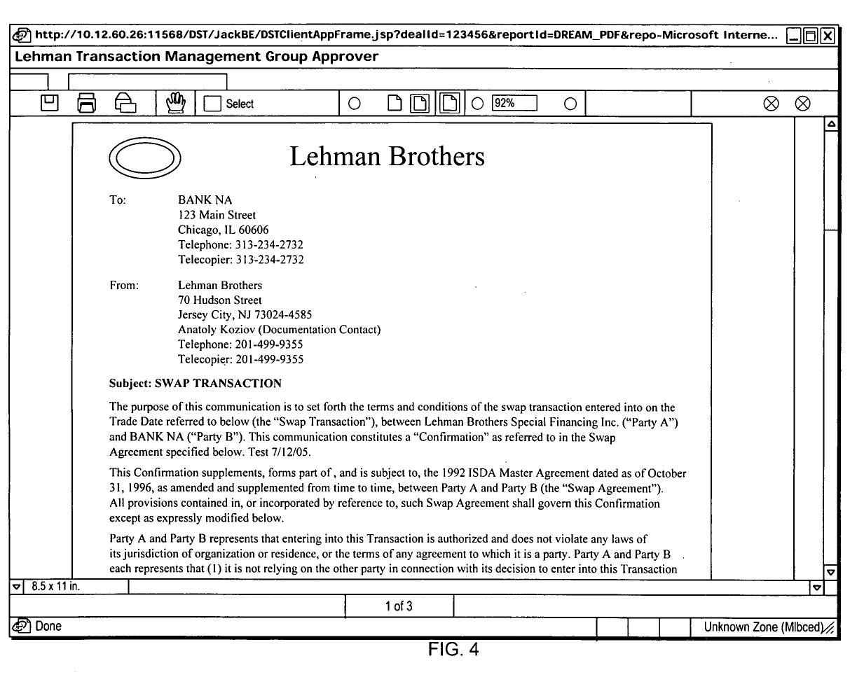

Raw data (such as trade data in an exemplary embodiment) is obtained from the company's front/middle office systems 100 via server 100 and that data is used to assemble a document using document assembly engine 102. With reference to the interface shown in FIG. 2, each line item 202 refers to a transaction document. Double-clicking on a document would result in the next action being taken. Thus, if the next action is “review”, double clicking on it will result in display of an editable version of the document (see FIG. 3). If the next action is “approve”, double clicking on it will show a PDF version of the document and a button at the top that allows the reviewer to approve or not approve (see FIG. 4).

Workflow engine 103 is used to route the document to an internal employee for review (see FIG. 3). The left side of the screen shown in FIG. 3 is a word processor to allow the user to edit the document; the right side of the screen is, in the exemplary embodiment, a trade data dictionary. After any editing is completed, the document can be saved (in document/trade repository 104) and closed. At this point, the document will be removed as a line item from the reviewer's screen (screen 200 of FIG. 3), and shown as a new line item on the person's screen responsible for approving.

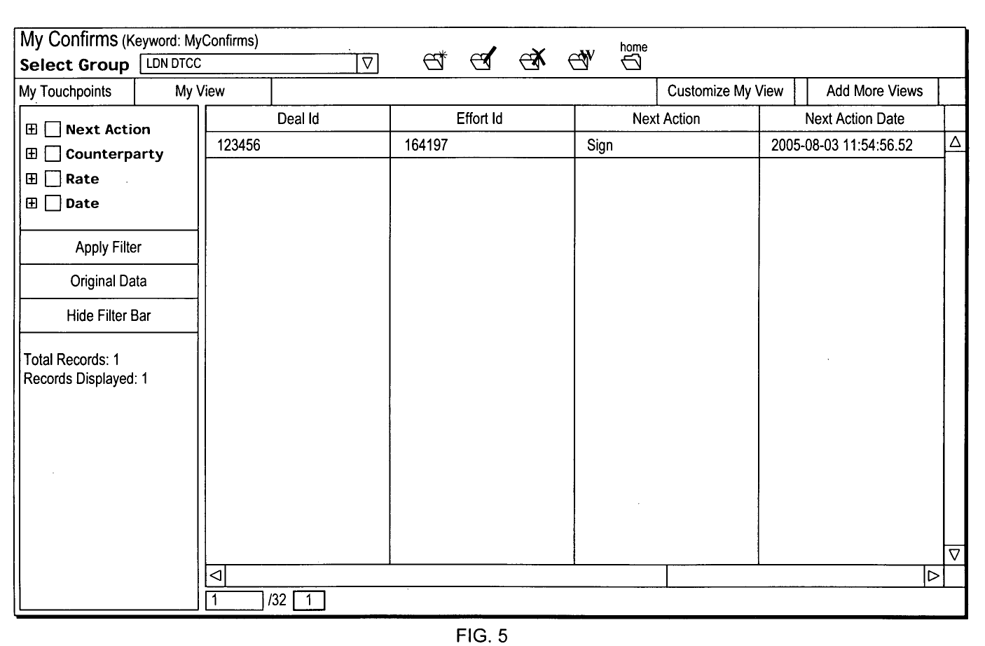

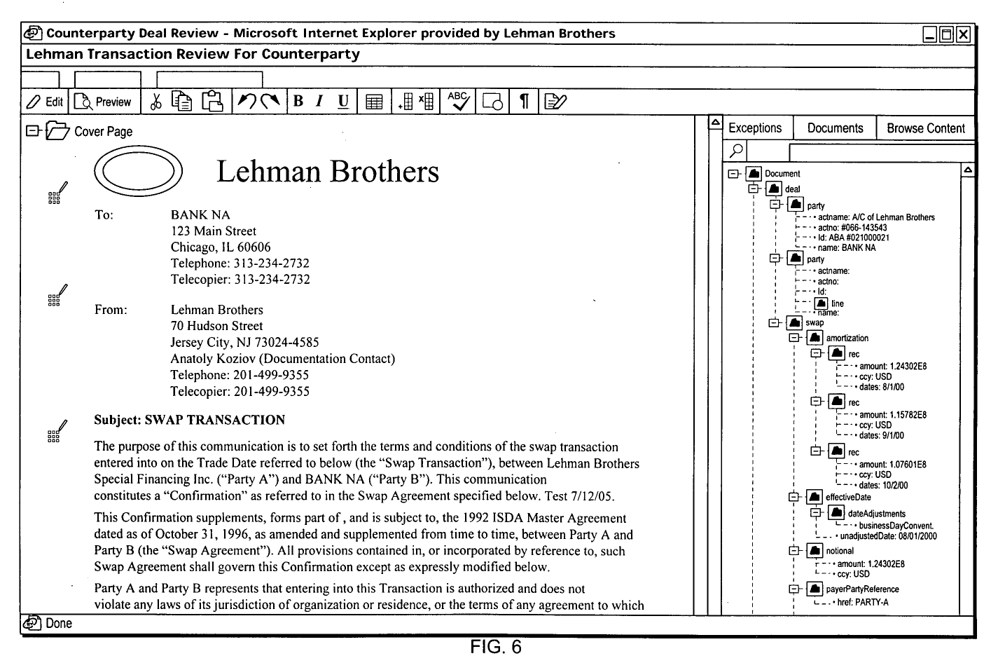

If critical data is changed, a reconciliation is done with the company's front/middle office systems 101. Workflow engine 103 is used to route the document to an internal employee for approval (see FIG. 5). The button at the top allows the reviewer to approve or not approve. If the document is not approved, it will be routed back to the reviewer; if the document is approved, it will be sent to the counterparty. Upon approval of the document, the counterparty is contacted (e.g., via email), inviting the counterparty to access the portal to review and edit or digitally sign the document (see FIG. 6). The ability to edit by the counterparty is the same as for the company, in the preferred embodiment. If the counterparty signs, the process is complete; however, if the counterparty amends, the amended document is routed back to an internal employee of the company for approval through the inventive system. The final copy of the document, plus all versions, are stored in document repository 104 for compliance and audit purposes.

Thus, the inventive process allows for a virtual web-based platform which allows for the alteration of documents by one or more parties. It is particular useful when used by parties with conflicting objectives (i.e., parties and counter parties), wherein a given party's access, permissions, workflows, etc. differ based on that party's identity and/or role (i.e., whether he is the party or the counterparty, and/or his specific role). In the preferred embodiment, the virtual web-based platform is behind the firewall of the party, which is accessed by the counterparty. In other embodiments, a secure platform is hosted by a third party who is trusted by both the party and the counterparty.

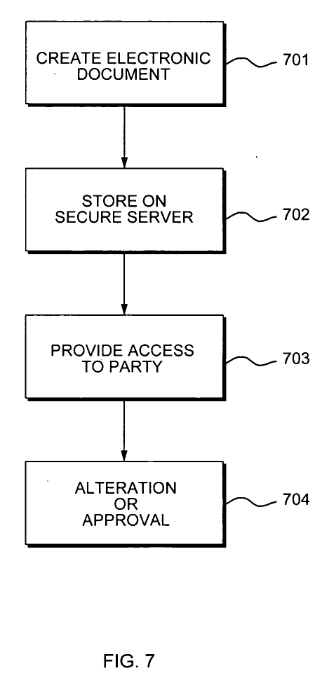

With reference to FIG. 7, a method for managing a workflow relating to an electronic document is shown. The workflow includes a plurality of steps. In step 701, the electronic document is created. In step 702, the electronic document is stored on a secure server. Access to the electronic document is provided to a party, in step 703. An alteration to the electronic document and/or an indication of approval is received from the party in connection with the workflow, in step 704. The steps of the workflow differ depending on the identity of party accessing the document (e.g., a party or a counterparty to a transaction).

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A document management system comprising:
a server that maintains an electronic document and software for managing a workflow relating to the electronic document, the workflow comprising a plurality of steps;
wherein one or more parties can access the electronic document via a network, use the software, and alter the electronic document; and
wherein the steps of the workflow differ depending on an identity of the party accessing the document.

2. The system of claim 1 wherein the parties comprise a party and a counterparty.

3. The system of claim 1 wherein the server is maintained behind a firewall of one of the parties.

4. The system of claim 1 wherein the server is maintained by a third party.

5. The system of claim 1 wherein the server is a secure server.

6. A method for managing a workflow relating to an electronic document, the workflow comprising a plurality of steps, the method comprising:
storing the electronic document on a server;
providing access to the electronic document to one or more parties; and
receiving from one or more of the parties one or more of an alteration to the electronic document and an indication of approval in connection with the workflow;
wherein the steps of the workflow differ depending on an identity of the party accessing the document.

7. The method of claim 6 wherein the parties comprise a party and a counterparty.

8. The method of claim 6 wherein the server is maintained behind a firewall of one of the parties.

9. The method of claim 6 wherein the server is maintained by a third party.

10. The method of claim 6 wherein the server is a secure server.

11. A method for managing a workflow relating to an electronic document maintained on a server, the workflow comprising a plurality of steps, the method comprising:
accessing the electronic document; and
performing one or more of altering the electronic document and indicating an approval of the electronic document;
wherein the steps of the workflow differ depending on an identity of a party accessing the document.

12. The method of claim 11 wherein at least two parties access the electronic document, the parties comprising a party and a counterparty.

13. The method of claim 11 wherein the server is maintained behind a firewall of a party.

14. The method of claim 11 wherein the server is maintained by a third party.

15. The method of claim 11 wherein the server is a secure server.

16. A computer readable medium having computer-executable instructions for performing the method of:
executing a workflow relating to an electronic document maintained on a server, the workflow comprising a plurality of steps that are performed by one or more parties, wherein the steps of the workflow differ depending on an identity of the party accessing the document.

17. The computer readable medium of claim 16 wherein the parties comprise a party and a counterparty.

18. The computer readable medium of claim 16 wherein the server is maintained behind a firewall of one of the parties.

19. The computer readable medium of claim 16 wherein the server is maintained by a third party.

20. The computer readable medium of claim 16 wherein the server is a secure server.
